(19) United States
(12) Patent Application Publication
(10) Pub. No.: US 2004/0094961 A1
(43) Pub. Date: May 20, 2004

(54) Tubing coupling

(76) Inventors: Andrew Richards, Aberdeen (GB); George Nigel Parkinson Webster, Aberdeen (GB)

Correspondence Address: Judith M Riley, Gifford Krass Groh Sprinkle Anderson & Citkowski, Suite 400, 280 N Old Woodward Avenue, Birmingham, MI, 48009, US

(21) Appl. No.: 10/468,943

(22) PCT Filed: Aug. 22, 2003
(86) PCT No.: PCT/GB02/00761

(30) Foreign Application Priority Data
Feb. 22, 2001 (GB) 0104378.5

(51) Int. Cl. F16L 19/00

(52) U.S. Cl. 285/370

(57) ABSTRACT

A tubular coupling member for use in the oil and gas exploration and extraction industries is disclosed. The tubular coupling member is adapted for coupling together lengths of tubing to form a tubing string and includes at least one protective radially extending element disposed on the outer surface thereof for protecting a cable or other medium which runs alongside the tubing string. In a preferred embodiment, the radially extending elements are radially protruding ribs which are equally disposed about the surface of the tubular coupling member.

The present invention relates to a tubular coupling member, particularly a tubular coupling member for coupling together lengths of tubing and providing protection for cables, tubing, wireline and the like running alongside the coupling.

In the oil and gas exploration and extraction industries, oil and gas normally flow to the surface from a hydrocarbon bearing formation via a production string comprising a plurality of pipes or lengths of tubing coupled together using what is essentially a short section of pipe having a larger bore than the tubing itself. Traditionally the coupling section has an internal thread machined therein which corresponds to external threads on the end exterior sections of the lengths of tubing which make up the production string.

In use, a production string is run into a well bore which is normally lined with a well bore casing. It is often required that a cable, thin bore tubing or any other medium is run downhole alongside the production string to supply a downhole tool of some description with power or control signals for example. An inherent problem with such an arrangement is that the medium is exposed to possible damage, particularly through contact between a coupling section and the well bore casing due to the coupling section having a larger outer diameter than a length of tubing.

The medium may contain a fibre optic or electrical conductors, or may be a hollow hydraulic tube or any combination thereof. Damage to any of these may lead to a loss of data or operability of the well and may in the worst case cause a safety hazard.

One known solution commonly used in the industry involves encasing the medium in a plastic or metal armour. Within this armour the medium is often further protected by at least one large metal wire known as a bumper bar which absorbs shock loading. Alternatively, or indeed in addition to encasing the medium, it is also known to provide protection at the point where damage is most likely to occur which is at the coupling sections. This is accomplished using a removable protection cage called a protector which fits over the coupling and the medium at that location.

Such protective methods are effective to a certain degree but they do have drawbacks. Among these is the increased cost and time to install and, although robust, if the protector falls or is knocked off it can present serious mechanical problems in the well. Furthermore, modern well architectures require multiple cables and tubings to be run in the well which adds to the complexity and cost of the current protective means.

It is an object of the present invention to obviate or mitigate at least one of the aforementioned disadvantages.

According to a first aspect of the present invention there is provided a tubular coupling member for coupling together lengths of tubing forming a tubing string, said coupling member having at least one protective radially extending element, said radially extending element extending substantially over the length of the coupling.

Preferably said coupling member has a plurality of protective radially extending elements extending substantially over the length of the coupling.

Most preferably said coupling member comprises four or five radially extending elements equiangularly disposed about the circumference of the coupling member.

Preferably said radially extending elements are radially protrusive longitudinal ribs provided on the external surface of the coupling member. Alternatively, said radially extending elements are longitudinal channels provided in the external surface of the coupling member.

Most preferably, where a plurality of radially extending elements are provided, said elements are rib elements.

Preferably said elements provide protection at the coupling member section to any medium or otherwise which is run alongside the tubing string. The term “medium” includes any cable-like structure which is likely to be or is normally run into a hydrocarbon producing well. This is achieved by having said radially extending elements projecting or recessing from the external surface of the coupling member by an amount equal to or greater than the largest diameter or height of any medium or otherwise which is to be protected. The preferred protective height or depth of the elements is in the range of 12 mm to 15 mm.

Preferably each rib provided on a coupling member has at least one shallow slot machined therein for receiving a tensionable band to fasten the medium requiring protection either within close proximity to a rib or securely in the channels between the ribs.

Preferably also each coupling member having a channel machined therein has at least one shallow tapered slot provided on either side of the channel for receiving a tensionable band to fasten the medium requiring protection securely within the channel.

Preferably when the coupling member is in a vertical position the leading and trailing ends of each of each rib are tapered from their outer surface towards the body of the coupling member. This increases the ease by which a tubing string comprising a coupling member as described herein is run into a hydrocarbon producing well, and also reduces the amount of damage sustained by the coupling member during the drawing process.

Preferably also the longitudinal outer edges of each rib are chamfered to reduce the damage caused to any well bore casing present in a well bore while running a tubing string comprising a coupling member as described herein into the well bore.

Preferably the coupling member further comprises an internal thread for engaging a corresponding thread on a tubing section.

Preferably there is provided an internal collar at the midsection of said coupling member which defines an aperture having a similar diameter to the inner diameter of a length of tubing.

The side faces of said internal collar provide a physical limit to the amount by which a length of tubing may be threaded into the coupling member.

Preferably gas tight sealing means are provided between the end faces of a length of tubing and the side face of an internal collar.

The coupling member as described herein may be manufactured by first forming a tubular member by extrusion, for example, with integral upstanding longitudinal ribs and then machining the threads and the lateral slots, tapers and chamfers in the ribs.

Alternatively a tube having an outer diameter equivalent to that of the outer diameter of the ribs and having an appropriate inner diameter may be formed by extrusion or centrifugal casting for example, and then machined to form the internal threads and to leave upstanding ribs which may then be machined to provide the lateral slots, tapers and chamfers. Alternatively the tube may be machined to form longitudinal channels and then further machined to form the tapered slots.

A further alternative method of manufacturing a coupling member may be to extrude a tube with a slight bulge so that the medium receiving channel may be machined in the bulged area. The threads and the lateral slots, tapers and chamfers may then subsequently be machined.

Another possibility may be, for example, to extrude or centrifugally cast a tube with a uniform outer diameter and weld or fix by any suitable means the required number of preformed ribs to its outer surface.

According to a second aspect of the present invention there is provided a tubing string comprising at least one coupling member in accordance with the first aspect.

Preferably each coupling member of a tubing string is aligned such that their radially extending elements are substantially collinear. This ensures that any medium or otherwise will run in the same general direction and will not follow a helical route around the tubing string.

If collinear alignment of the elements is not achieved there is a potential maximum angular alignment error of 180°, both clockwise and anti-clockwise, between coupling members each comprising a single radially extending element. Accordingly, the coupling members are provided with a plurality of elements which proportionally reduce the aforesaid angular alignment error.

If collinear alignment is not achieved by coupling members having four or five elements, then the maximum angular alignment error will be 45° or 36° respectively. This significantly reduces the extent to which any medium or otherwise will spiral around the tubing string.

These and other aspects of embodiments of the present invention will now be described, by way of example, with reference to the accompanying diagrams in which:

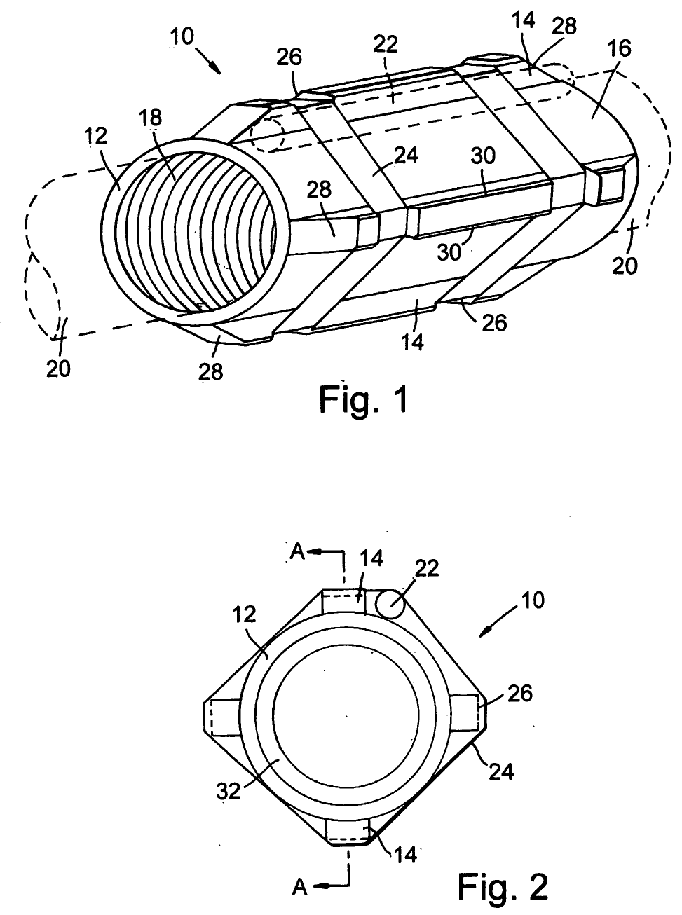

FIG. 1 is an end perspective view of a coupling member in accordance with a preferred embodiment of the present invention;

FIG. 2 is an end view of the coupling member of FIG. 1;

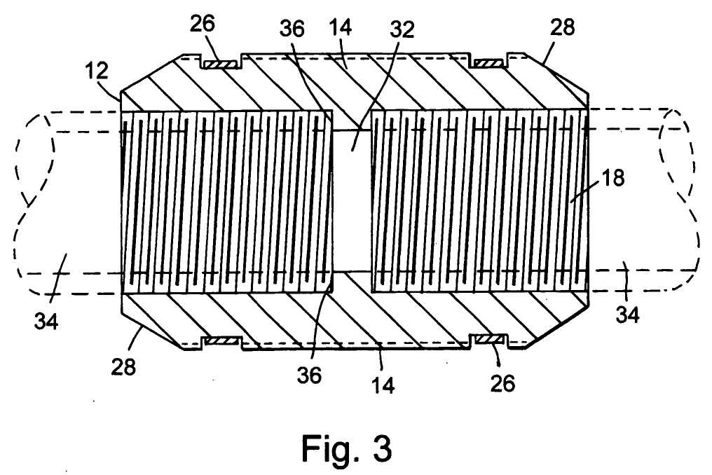

FIG. 3 is a longitudinal sectional view of FIG. 2 taken on line A-A of FIG. 2;

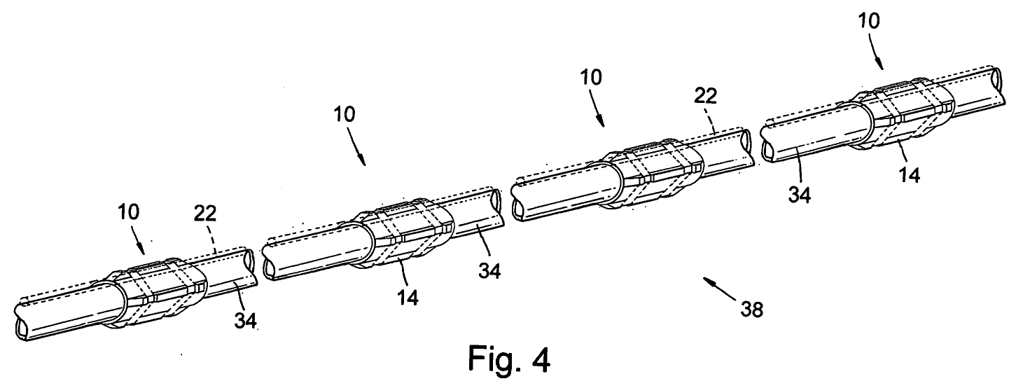

FIG. 4 is a diagrammatic view of a tubing string with tubular elements joined by a plurality of coupling members as shown in FIG. 1;

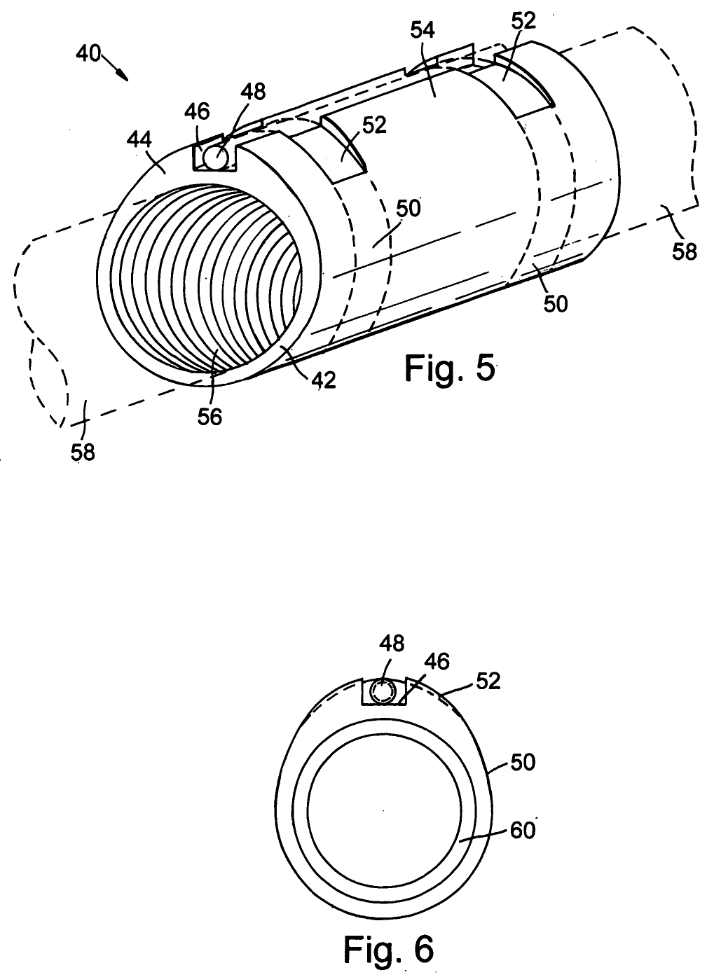

FIG. 5 is an end perspective view of a coupling member in accordance with an alternative embodiment of the present invention, and

FIG. 6 is an end view of the coupling member of FIG. 5.

Reference is first made to FIG. 1 which depicts a coupling member, generally indicated by reference numeral 10, which comprises a tubular steel member 12 and four radially upstanding longitudinal ribs 14 of approximately 12-15 mm in height provided on the external surface 16 of the tubular section 12. The ribs 14 are equally disposed about the periphery of the tubular section 12 such that they are angularly spaced by 90°.

The coupling member 10 also has an internal thread 18 on the inner surface of the tubular section 12 for receiving a mating external thread provided on a length of tubing 20 (shown in broken outline). A cable 22 (shown in broken outline) is shown in its protected position and is held in place by two steel tensionable bands 24 wrapped around the upstanding ribs 14.

Provided in each rib 14 are two shallow lateral slots 26 located near either end of the rib 14 with each end of the rib having tapered portions 28 to increase the ease by which a tubing string is run into a well bore and reduce the amount of damage sustained by the coupling member during the drawing process. Further, the longitudinal outer edges of each rib 14 have chamfered portions 30 to reduce damage caused to any casing present in a well bore.

Reference is now made to FIG. 2 which shows an end view of the coupling member 10 of FIG. 1. The cable 22 runs along the outside of the tubular section 12 adjacent to the protecting rib 14. The cable 22 is held in the position shown by the tensioned steel band 24 which is secured in the lateral slots 26 by the band.

The coupling member 10 has an internal collar 32 located at its mid-section to which the length of tubing 20 forming part of a tubing string sealably abuts when the length of tubing 20 is screwed into the coupling member 10 to its fullest extent.

Reference is now made to FIG. 3 which is a longitudinal sectional view of FIG. 2 along A-A. The tubular section 12, ribs 14 and internal collar 32 are integrally formed and the tapered portions 28 and lateral slots 26 in the ribs 14 and the internal thread 18 in the tubular section 12 are machined after the initial shape is formed by extrusion. Sections of tubing 34 (shown in broken outline) are screwed into coupling member 10 and, when fully inserted, abut the internal collar 32 with gas tight seals 36 provided therebetween. The internal collar 32 extends radially inwards by an amount equivalent to the wall thickness of the lengths of tubing 34 so that the internal bore diameter is the same as the bore diameter of the tubing to facilitate flow and passage through the made-up string.

FIG. 4 shows a diagrammatic view of a tubing string 38 comprising lengths of tubing 34 coupled together by ribbed coupling members 10. As can be seen, the coupling members 10 are aligned such that their ribs 14 are substantially collinear. This feature reduces the amount by which a cable 22 (shown in broken outline) will spiral around the tubing string 38.

Reference is now made to FIG. 5 which depicts a coupling member 40 in accordance with an alternative embodiment of the present invention. The coupling member is a steel tubular section 42 with a bulged area 44 containing a longitudinal channel 46 approximately 15 mm deep for receiving a cable 48 of circular cross-section (shown in broken outline). The cable 48 is held within the channel 46 by tensionable bands 50 (shown in broken outline) wrapped around the outer surface of the coupling member 40. Tapered recesses 52 are machined in the surface 54 of the member to locate bands 50 to prevent slippage along the coupling member 40. An internal thread 56 is provided on the inner surface of the coupling member 40 to couple together lengths of tubing 58 (shown in broken outline) to form a tubing string.

The coupling member 40 shown in FIG. 5 is formed by first extruding the tubular section 42 with the bulged area 44 and subsequently machining the channel 46, tapered recesses 52 and the internal thread 56.

FIG. 6, which is an end view of the coupling member 40 of FIG. 5, shows the cable 48 positioned in the channel 46 and held in place by a tensionable band 50. As with the coupling member 10 of FIGS. 1, 2 and 3, an internal collar 60 is provided at the mid-section of the coupling member 40 for the same reasons.

Various modifications may be made to the embodiments hereinbefore described without departing from the scope of the invention. For example, the coupling member may be made of any suitable material, such as stainless steel, wrought iron, Inconel or a composite (metal/polymer) etc. The ribs may be made of a different material to the coupling member body especially if the ribs are welded to the body. The cross-section of the ribs may be arched as well as rectangular or trapezoidal.

Any suitable number of lateral slots and tapered recesses may be machined in the coupling member to accommodate the required number of tensionable bands which may be made from any suitable material which adequately supports tensile loading.

More than one cable may be used with the coupling members and to accommodate different cable sizes coupling members with different heights of ribs and depth of channel may be manufactured.

Coupling members having longitudinal channels may be manufactured with tapered ends to limit damage sustained to the coupling or a well bore during the drawing process.

The principal advantage of the present invention is that it eliminates the requirement for a protective cage structure to be placed over conventional coupling members to protect cable-like structures running alongside a tubing string.

Further advantages of the present invention are that the coupling members can be manufactured in a variety of ways from a variety of materials. They can also be readily manufactured with any suitable number of ribs or channels to provide protection for a selected number of cables. In addition, the ribs and channels themselves can readily be produced within a range of heights and depths respectively to accommodate for varying sizes of cables and the like.

1. A tubular coupling member for coupling together lengths of tubing forming a tubing string, said coupling member having at least one protective radially extending element, said radially extending element extending substantially over the length of the coupling.

2. A coupling member as claimed in claim 1, wherein said coupling member has a plurality of protective radially extending elements extending substantially over the length of the coupling.

3. A coupling member as claimed in claim 1 or 2, wherein said coupling member has four protective radially extending elements equiangularly disposed about the circumference of the coupling member.

4. A coupling member as claimed in claim 1 or 2, wherein said coupling member has five protective radially extending elements equiangularly disposed about the circumference of the coupling member.

5. A coupling member as claimed in any preceding claim, wherein said radially extending elements are radially protrusive longitudinal ribs provided on the external surface of the coupling member.

6. A coupling member as claimed in claim 5, wherein the longitudinal ribs have a protective height in the range of 12 mm to 15 mm.

7. A coupling member as claimed in claim 5 or 6, wherein each rib has at least one shallow slot machined therein for receiving a tensionable band to fasten a medium requiring protection either within close proximity to a rib or securely in the channels between the ribs.

8. A coupling member as claimed in claim 5, 6 or 7, wherein the ends of each rib are tapered from their outer surface towards the surface of the coupling member.

9. A coupling member as claimed in any one of claims 5 to 8, wherein the longitudinal outer edges of each rib are chamfered to reduce the damage caused to any well bore casing present in a well bore while running a tubing string comprising a coupling member.

10. A coupling member as claimed in any one of claims 1 to 4, wherein said at least one radially extending element is a longitudinal channel provided in the external surface of the coupling member.

11. A coupling member as claimed in claim 10, wherein the longitudinal channels have a protective depth in the range of 12 mm to 15 mm.

12. A coupling member as claimed in claim 10 or 11, wherein at least one shallow tapered slot is provided on either side of the channel for receiving a tensionable band to fasten a medium requiring protection securely within the channel.

13. A coupling member as claimed in any preceding claim, wherein the coupling member further comprises an internal thread.

14. A coupling member as claimed in any preceding claim, wherein there is provided an internal collar at the midsection of said coupling member which defines an aperture having a similar diameter to the inner diameter of a length of tubing.

15. A coupling member as claimed in claim 14, wherein the internal collar includes sealing means on the side faces thereof in order to provided gas tight sealing means between the end faces of a length of tubing and the side face of the internal collar.

16. A coupling member as claimed in claim 1, wherein the coupling member is an extrusion.

17. A coupling member as claimed in claim 1, wherein the at least one radially extending element is integral with the coupling member.

18. A coupling member as claimed in claim 1, wherein the at least one radially extending element is machined in the coupling member.

19. A coupling member as claimed in claim 1, wherein the at least one radially extending element is fixed to the coupling member.

20. A coupling member as claimed in claim 16, wherein the coupling member is extruded with a constant outer diameter.

21. A coupling member as claimed in claim 16, wherein the coupling member is an extruded tube having a bulge and having at least one radially extending machined element in the bulged area.

22. A coupling member as claimed in claim 1, wherein an internal thread is machined in the coupling member.

23. A tubing string including at least two coupling members in accordance with any preceding claim wherein each coupling member is aligned such that their respective at least one radially extending elements are substantially collinear.
